(19) United States
(12) Patent Application Publication
(10) Pub. No.: US 2007/0201672 A1
(43) Pub. Date: Aug. 30, 2007

(54) SELECTIVE TELEPHONY FUNCTIONS

(76) Inventors: Per Hallberg, Vange (SE); Tor-Bjorn Hallberg, Vange (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 11/737,105

(22) Filed: Apr. 18, 2007

Related U.S. Application Data
(63) Continuation-in-part of application No. 10/711,804, filed on Oct. 6, 2004, now abandoned.

(51) Int. Cl. H04M 3/00; H04M 5/00

(52) U.S. Cl. 379/252

(57) ABSTRACT

Communication devices, such a telephones, are connected to one another so that they are reachable by at least a first identity. Each communication device is programmable to let through only identities that are stored. For example, this could mean that only one of many devices permits the identity to go through. In this way, the contact attempt is selectively permitted to go through to only certain devices in a group of devices that all have at least one common identity. The system may be used for telephoning, IP-communication and other digital signaling security solutions.

### PRIOR APPLICATION

This is a continuation-in-part patent application based on U.S. patent application Ser. No. 10/711,804, filed 6 Oct. 2004.

### TECHNICAL FIELD

The present invention relates to a method for letting a telephone call through to only certain pre-programmed telephone units and to make those units ring while the same call is not permitted by or permitted to go through to other telephone units although all the telephone units may be associated with at least one telephone number.

### BACKGROUND AND SUMMARY OF THE INVENTION

Many telephone users or subscribers want to be able to control incoming calls with different functions without having to necessarily add on additional services to the telephone subscription. Many unwanted calls may be directed to a first subscriber. The subscriber may not be able to handle these in a good way. The subscriber stills wants to be reachable and to get in direct contact with one or many members in one or many groups. Conventional blocking systems often allow the unwanted phone call to enter the telephone but is later blocked so that the user does not have to answer the unwanted phone call. One major drawback of these systems is that the user must periodically empty the telephone from all the blocked or unwanted calls and messages. The user often does not want to know who was blocked or the number of unidentified calls that have been received. The user may then often be forced to turn off the telephone to prevent having to waste time on clearing various memories of unwanted phone calls and to ensure that the user is not disturbed. However, SMS messages, for example, will occur as soon as the telephone is turned on again. It is in this way almost impossible to avoid receiving SMS message although the conventional telephone is turned off.

According to the present invention, the first subscriber may avoid unwanted calls completely or partially depending upon which status the first subscriber assigns each caller. By using the method of the present invention, the user has total control of all messages that are let through to the communications unit. This should be achievable without obtaining confidential numbers that may be obtained in different ways.

Another way that is used is to assign codes and similar information to selected callers so that calls are let through and that the first subscriber has a code reader that only lets through calls that have been preceded with a code that is stored in a list. The first subscriber must establish a register for who has the codes and continuously update this. Another problem is that the party with the code must keep track of the code. Another drawback is that code systems are limited because the first subscriber must be able to predict who is going to call and have important messages. It would of course be better if the fist subscriber could determine which parties that are permitted to be let through to the first subscriber without having to inform the desirable caller in advance.

### SUMMARY OF THE INVENTION

One object of the present invention is to devise a selection-technique for letting calls through to a first telephone from one or many predetermined groups of other caller so that the selection technique does not require providing these other callers with codes in order to reach the first communication device.

The present invention takes advantage of adding identity information to the incoming signal of the other caller that can be read by a sensor in the first communication device before the call is let through to activate or ring the first communication device.

The present invention also uses one or many registers that the first subscriber may establish for numbers of other callers that are to be let through. This register can work so that all callers in the list are not let through to the first telephone or are only let through during certain time periods to one of many registers (message register, let-through registers etc.). The registers may also work so that all the listed callers are let through at least during certain time-periods.

Many different registers may be established so that the first subscriber can select which register is temporarily active or the subscriber can select many active registers during certain time periods or select so that all callers, who send signals that include information about the identity of the caller are let through.

The first subscriber may have prepared messages and forwarding functions to selectively or group-wise send the calls to registers that have been established for the incoming calls.

The present invention may in a simple form only block calls that are not identifiable and thus include telephone numbers that could not be identified. Additionally, the present invention includes an additional register for allowed callers. The system of the present invention has a comparator arrangement that is arranged to let through calls from identified telephone numbers included in the register. The system of the present may not only be implemented with a separate arrangement but also be built into the telephone or be available from the telephone operator.

The registers may be directly programmed by the first subscriber. The present invention is described in connection with telephone calls but it is to be understood that the present invention includes all telephone communication or signaling communication in general and includes all signaling arrangements.

The system of the present invention may be installed in each telephone unit so that only the registers in each telephone unit may be set individually. In this way, only one telephone unit, for example, may ring because it is the only telephone unit that is set to let through the caller. This telephone unit may be the only telephone unit ringing and activated although there are many telephone units, that do not let the caller through, associated with the same telephone number in a household.

### BRIEF DESCRIPTION OF THE DRAWINGS

Examples of the invention are illustrated in the appended drawings of which:

FIG. 1 is a schematic view of a first embodiment of a system of the present invention;

FIG. 2 is a schematic view of a second embodiment of the system of the present invention;

FIG. 3 is a schematic view of both the first and second embodiments integrated into one drawing; and

FIG. 4 is a schematic view of a third embodiment of the system of the present invention.

### DETAILED DESCRIPTION

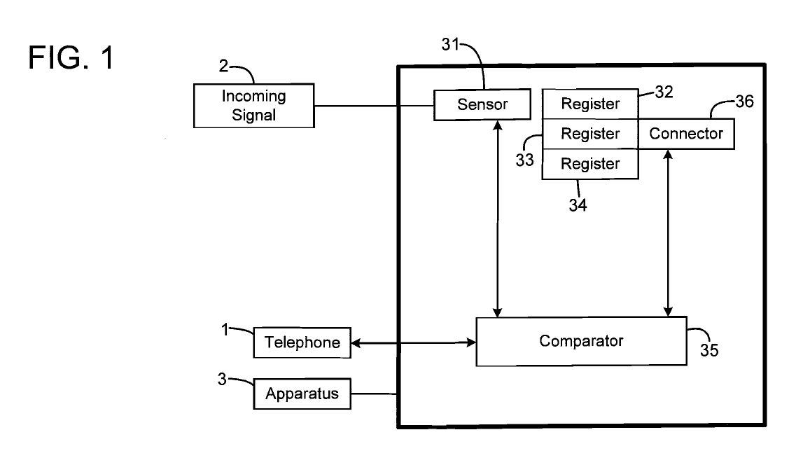

FIG. 1 shows a telephone 1 of a first subscriber and is schematically illustrated as having an incoming signal 2 via a telephony network. The signal 2 is assumed to include information about the identity of the caller. An apparatus 3 according to the present invention is connected between the telephony network and the telephone 1 of the first subscriber. The apparatus has a sensor 31 that senses the identity of the sender of the signal 2. There is at least a register 32, and preferably also additional registers 33, 34. These registers include information about the identity of other subscribers to determine which calls 2 are permitted through to the first subscriber. The apparatus has a comparator 35. For example, when the register 32 is active while the other registers 33, 34 are inactive and when the register 32 includes the identity of the subscribers who are to be let through, the comparator 35 may be arranged to let through calls 2 when the identity information can be sensed by the sensor 31 and are included in the register 32 so that the call only reaches the telephone 1 when those two conditions are met.

In the alternative, the register 32 may be of a type that includes identity information about subscribers whose calls are not be let through to the telephone 1 of the first subscriber or only be let through to a message register 33 wherein the comparator 35 conducts the comparison.

As illustrated in FIG. 1, the arrangement may include a connection arrangement 36 to provide for a selective connection of one or many of the registers 32-34. In one embodiment, the connection arrangement 36 may be controlled by time, such as 24 hours, weekly, monthly etc. The registers 32-34 can include other different categories of the caller's access to each respective register.

The registers 32-34 may be such that the first subscribers may add and delete information in the registers. In a corresponding way, the connection arrangement 36 may be designed to be controlled or adapted by the first subscriber.

The arrangement 3 may be made as a separate unit which are marketed and sold to consumers for connection between the network/communication-signal. It is assumed that the first subscriber 1 is in agreement with the network/communication-signal operator that the operators shall include information in the signal of the incoming call regarding the identity of the caller.

It should be understood that the functions, that are illustrated in the arrangement 3, completely or partially be implemented in the equipment of the operator of the network/communication-signal. The first subscriber 1 may be able to program the registers 32-34 and the connection 36 via the network/communication signals of the operator if the first subscriber can show it has the authority to do so via for example the calling signal.

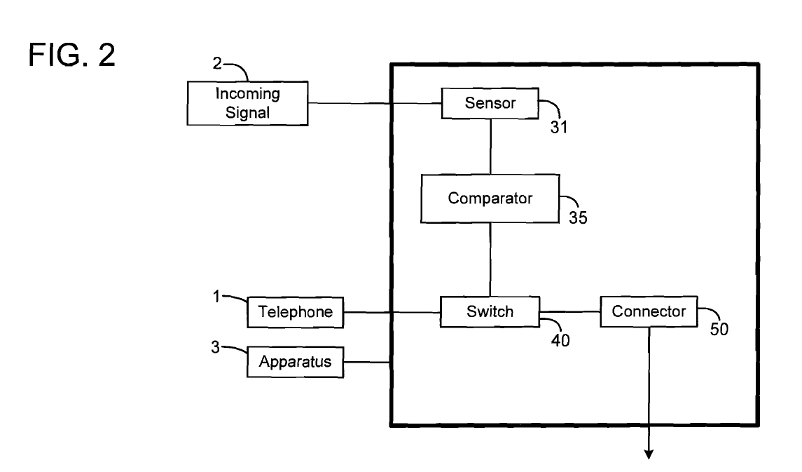

The embodiment of FIG. 2 is a further development of the customer concept so that the arrangement 40 is provided. Calls may be forwarded by the comparator 35 but that are not received by the switch 40 to a connecting arrangement 50 that forwards calls to another when the first subscriber is available.

In the alternative, the illustrated arrangement 50 may include prepared messages that are selectively distributed to the other callers.

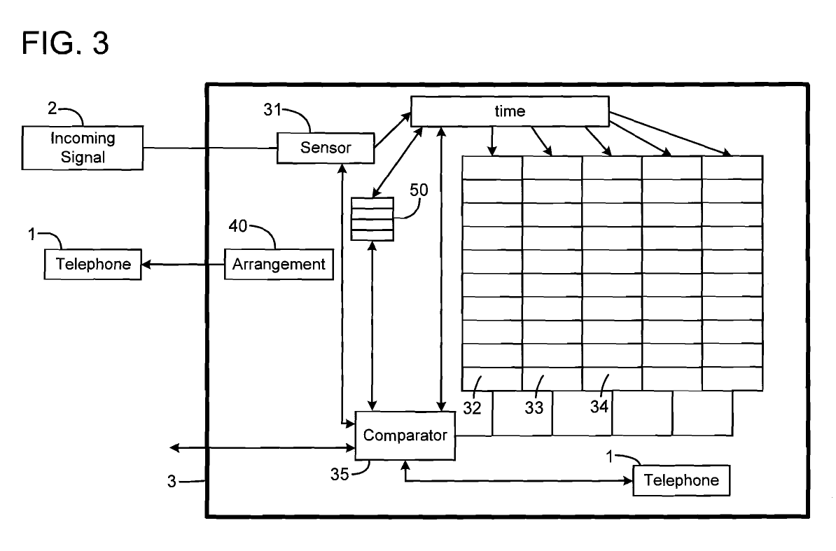

In another aspect of the invention, the calling subscribers may first get in contact with a message register that is arranged to give messages, sms or other message forms to calling subscribers so that the messages to the caller can be selective and adapted to the identity of the caller. The message register can be arranged to terminate the call after the message has been given. Thus, the register may forward calls from other subscribers that do not have messages for processing in the system according to FIGS. 1, 2 or 3. Furthermore, the register can be arranged to eliminate messages after they have passed a predetermined time control or after the message have been given so that later calls from the specific second subscriber is forwarded to the system according to FIGS. 1-3.

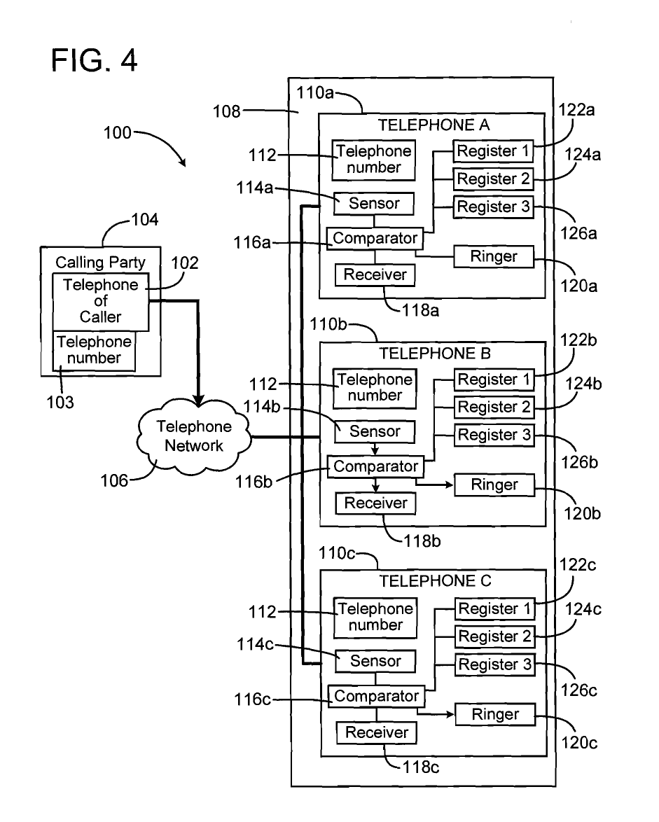

With reference to FIG. 4, a third embodiment of the system 100 of the present invention is illustrated. The system 100 has a calling communication device 102 associated with a calling telephone number 103 of a calling party 104 connectable via a telephone network 106 to a receiving entity 108 having three telephones 110a, 110b, 110c that are all associated with and reachable by the same receiving telephone number 112. The telephones 110a, 110b and 110c may be serially connected to one another or connected in parallel. It is to be understood that the present invention is not limited to telephones and may be used in connection with any suitable electronic communication devices. The telephones are merely used as illustrative examples.

Preferably, each telephone 110a-c has a sensor 114a-c electrically connected to a comparator 116a-c that is electrically connected to a receiver 118a-c, a ringer 120a-c and registers 122a-c, 124a-c and 126a-c. It may be possible to have the sensor, comparator, registers and comparators in a unit that is separate from the telephone.

An important feature of the system 100 of the present invention is that the registers of each telephone 110a, 110b and 110c may be set to behave differently although they are all reachable by the same telephone number 112. For example, this means that only one telephone will ring when a certain caller calls because only that telephone is set to permit phone calls from the calling telephone number to go through while the other telephone units block phone calls received from the calling telephone number. Another important feature is that the emphasis is on letting certain calling telephone numbers through to the receiving telephone. This is different from conventional systems that accept all phone calls and then block certain phone calls via filters so that it may be necessary to periodically empty all the blocked calls from a memory. In the current invention, there is no need to empty blocked calls since they are never let through and cannot therefore be saved in the telephone.

For example, the register 122a of the telephone 110a may be set to include the telephone number 103 as an allowable telephone number while none of the registers of the telephones 110b and 110c include telephone number 103 as an allowable telephone number. In this way, the user may add all telephone numbers from which the user would like to receive telephone calls to telephone 110a so that the comparator 116a will find the telephone number 103 in register 122a when a telephone call is received from telephone number 103 as identified by sensor 114a. This means only telephone 110a will ring and let the call from telephone number 103 through to the receiver 118a although all three telephones 110a-c are reachable by the same telephone number 112.

In operation when receiving a telephone call at telephone number 112, the sensors 114a, 114b and 114c all sense the incoming telephone number such as telephone number 103 from telephone 102 when the caller 104 calls. The sensors send the sensed incoming telephone number as sensor signals to the comparators 116a-c. If no telephone number is sensed, the sensors may be set so that no sensor signals are sent to the comparators 118a-c so that the phone call is terminated without activating the comparators. Optionally, a message may be sent to the calling communication device of the caller to inform the caller that no telephone number could be identified and that the telephone call will be terminated. This could happen if the calling communication device is associated with a confidential telephone number. Also, the sensors could be programmed to only send the sensor signal to the comparators when the calling telephone number is identified and received within an allowable time period. If the incoming telephone call is identified but the call is received outside the allowable time-period, the incoming telephone is rejected without passing any information to the comparator and/or the receiver of the telephone. Optionally, a rejection message or busy signal is sent to the calling communication device to inform the caller that the call is made outside the allowable time-period.

Upon receipt of the sensor signal from the sensors, the comparators will search the active registers. For example, the comparator 116a may receive a sensor signal from the sensor 114a including the sensed telephone number 103. The comparator 116a determines which of the registers 122a, 124a or 126a is active or switched on. Preferably, only one register may be active at the time. Of course, many or all the registers may be simultaneously active also. When only register 122a is active, the telephone number 103 is searched for in register 122a. If no telephone number 103 can be found in register 122a then the telephone call is blocked without letting the phone call through to the ringer 120a or the receiver 118a. Optionally, a message is sent to the telephone 102 informing that the telephone number 103 is not allowable to be let through at this time. Also, it may be possible to set up the system 100 so that the rejection message is only sent back to telephone 102 when the telephone number 103 does not exist in any of the active registers of telephones 110b or 110c either. For example, the comparator 116a may send a no-find signal to the comparator 116b so that the comparator 116b is informed that the call was rejected by telephone 110a so that it may be necessary to send back a rejection signal to telephone 102 if telephone number 103 cannot be found in any active register of telephones 110b and 110c either. There is no need to send back a rejection message to the telephone 102 if one of the telephones 110b or 110c has the telephone number 103 in an active register. This is one reason why it is preferable that the comparator 116b knows that the call was not let through to telephone 110a.

Similarly, the comparator 116b searches the active registers of telephone 110b such as register 122b and comparator 118b searches the active registers of telephone 110c. Assuming that neither telephone 110b or telephone 110c has any active registers that include the telephone number 103 then none of the telephones 110b or 110c will ring and the call is not let though to the receivers 118b or 118c. In this way, only telephone 110a will ring and can receive the telephone call from telephone number 103 while the telephones 110b and 110c both do not respond to the call from telephone number 103 of telephone 102.

Since each telephone has several registers, the user may change the behavior of the telephones by either changing or updating the registers or activating the second and/or third register of the telephone. For example, the user may switch the active register from register 122a to register 122b. If register 122b is programmed to include different allowable telephone numbers then the telephone 110a will allow different numbers to the ringer 120a and the receiver 118a. It may also be possible to associate allowable time-periods during which calls from the calling telephone number are permitted to go through to the receiver and the ringer. In this case, the comparator must not only find the calling telephone number in the active register but also check to make sure the calling telephone number is making the call during an allowable time-period, such as between 5-7 pm on Wednesdays. It may also be possible to customize the type of call that is allowed. For example, the sensor may distinguish between conventional voice calls, SMS, MMS or other communication messages so that the registers may be set differently for each communication type. It is also possible to separate the incoming phone calls based on country or area codes.

If telephone number 103 cannot be found in neither register 122a or register 122b, then the comparator 116b may send a no-find signal to comparator 116c. If telephone number 103 is not found in any of the active registers of 110c, such as register 122c, then the system 100 knows that telephone number 103 is not permitted through by any of the active registers of telephones 110a, 110b or 110c. This means a rejection message may be sent back to telephone 102 to inform the calling party 104 that telephone number 103 is not permitted by any of the active registers of any of the telephones 110a, 110b or 110c.

It may also be possible to include an administration code with each phone to prevent unwanted changes of the programming of each telephone unit. This means no changes can be made unless the correct administration code is first entered.

It is also possible include all the features of the present invention in a centrally administered unit such as a server operated by the telephone operator so that the operator may charge the user for the services provided.

It is possible permit an identification code that applies to one subscriber, such as a company, so that although calls are made from different telephone units with different telephone numbers, all the units will be sensed with the same identification code by the sensor of the system of the present invention. It may also be possible to include non-erasable main registers in the telephones of the employees so that the employee is not permitted to make certain changes of the registers unless the correct administration code is provided.

Information may be transferred between local registers within each telephone or between telephones. Information may also be transferred between the system of the current invention and external units such as computers and other electronic equipment that communicate by wire or wireless communication technologies including Bluetooth, infrared or any other suitable wireless technology.

It may be possible to automatically switch between the primary first register and the secondary first register during certain time periods so that the telephone automatically makes the primary first register active during a first time-period and the secondary first register during a second time-period.

While the present invention has been described in accordance with preferred compositions and embodiments, it is to be understood that certain substitutions and alterations may be made thereto without departing from the spirit and scope of the following claims.

1-18. (canceled)

19. A method of managing incoming calls from a calling party, comprising:
providing a calling communication device of a calling party being reachable by a calling telephone number, a telephone network and a first communication device and a second communication device of a receiving party, the first communication device being reachable by a first telephone number and the second communication device being reachable by the first telephone number,
adding the calling telephone number to a first register of the first communication device and excluding the calling telephone number from a second register of the second communication device,
the calling party calling from the calling communication device to the first telephone number,
a first sensor of the first communication device sensing the calling telephone number from the calling communication device,
a first comparator of the first communication device receiving information about the calling telephone number from the first sensor, the first comparator searching and finding the calling telephone number in the first register of the first communication device,
the first comparator sending a trigger signal to a first ringer to trigger the first ringer to ring and letting the calling party to a first receiver of the first communication device,
a second sensor of the second communication device sensing the calling telephone number from the calling communication device,
a second comparator of the second communication device receiving information about the calling telephone number, the second comparator searching and not finding the calling telephone number in the second register of the second communication device,
the second comparator terminating the call from the calling communication device without ringing a second ringer of the second communication device or letting the calling communication device through to a second receiver of the second communication device so that the calling party is only let through to the first communication device although the first and second communication devices are both reachable by the first telephone number.

20. The method according to claim 19 wherein the method further comprises sending a rejection signal or busy signal back to the calling communication device when the calling telephone number is not found in any active register of the first communication device or the second communication device.

21. The method according to claim 19 wherein the method further comprises associating an allowable time-period to each telephone number stored in the first register.

22. The method according to claim 19 wherein the method further comprises sending a rejection message to the calling communication device when the calling telephone number cannot be identified by the first sensor.

23. The method according to claim 19 wherein the method further comprises the first communication device making the primary first register active during a first time-period and making the secondary first register active during a second time-period.

24. The method according to claim 19 wherein the method further comprises the first communication device sending a no-find signal to the second communication device when the calling telephone number is not found in the primary first register.

25. The method according to claim 19 wherein the method further comprises the first sensor only sending the sensor signal to the first comparator when the calling telephone number is identified and received within an allowable time period.

26. A method of managing incoming calls from a calling party, comprising:
providing a calling communication device of a calling party being reachable by a calling telephone number, a telephone network and a first communication device and a second communication device of a receiving party, the first communication device being reachable by a first telephone number and the second communication device being reachable by the first telephone number,
the first communication device having a primary first register and a secondary first register, setting the primary first register in an active mode and the secondary first register in an inactive mode;
adding the calling telephone number to a primary first register of the first communication device and excluding the calling telephone number from a second register of the second communication device,
the calling party calling from the calling communication device to the first telephone number,
a first sensor of the first communication device sensing the calling telephone number from the calling communication device,
a first comparator of the first communication device receiving information about the calling telephone number from the first sensor, the first comparator searching the primary first register without finding the calling telephone number in the first register of the first communication device,
the first comparator sending a no-find signal to a second comparator of the second communication device,
a second sensor of the second communication device sensing the calling telephone number from the calling communication device,
the second comparator of the second communication device receiving information about the calling telephone number and the no-find signal from the first comparator, the second comparator searching without finding the calling telephone number in the second register of the second communication device,
the second comparator terminating the call from the calling communication device without ringing a second ringer of the second communication device or letting the calling communication device through to a second receiver of the second communication device, and
the second communication device sending a rejection signal back to the calling communication device.
